(19) United States
(12) Patent Application Publication
(10) Pub. No.: US 2005/0287274 A1
(43) Pub. Date: Dec. 29, 2005

(54) Soups comprising dietary fiber gel

(76) Inventors: Triveni P. Shukla, Mukwonago, WI (US); Gregory J. Halpern, Vernon Hills, IL (US)

Correspondence Address: Fullin Legal Services LLC, 711 N. Milwaukee Avenue, Libertyville, IL, 60048, US

(21) Appl. No.: 10/878,837

(22) Filed: Jun. 28, 2004

(51) Int. Cl. C12C 1/027

(52) U.S. Cl. 426/589

(57) ABSTRACT

According to the present invention, fat and caloric content of soups can be reduced by the replacement of a portion fat content normally found in soups with an equal amount of dietary fiber. The result is that fat and caloric content of soups can be manipulated with minimal effect on taste and texture. Furthermore, the soups can further comprise functional foods that increase health and nutritional benefits of the soups. The functional foods can be added individually, and in any combination thereof. Hence, in addition to reducing fat and caloric content of soups by replacing a portion of fat with dietary fiber gel, additional health benefits can be achieved with compositions that include functional foods.

### CROSS-REFERENCE TO RELATED APPLICATIONS

Not Applicable.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to soups comprising dietary fiber gel. Recent media attention to the global problem of obesity demonstrates a need for greater availability of foods with low caloric and fat content. This is especially true for foods that often have high fat and caloric content, such as soups.

Soups typically comprise some fat. Other ingredients can vary according to the type of soup and the recipe followed, but often, soups are high in both fat and caloric content.

In recent years, some companies have begun to offer reduced fat soups. This variety of soup, however, often fails to retain the desirable taste and texture of soups comprising higher fat contents.

Accordingly, there is a need for reduced fat and caloric content soups that has the desirable flavor and texture of high fat and high caloric content soups.

### BRIEF SUMMARY OF THE INVENTION

A composition of matter for use in producing high-fiber, low-calorie and low-fat soups is provided. The composition includes dietary fiber gel that replaces fat in soups. In addition, compositions are provided that include dietary fiber gel and other functional ingredients for nutritionally fortified soups.

### DETAILED DESCRIPTION OF THE PREFERRED EMBODIMENT

The following description provides for the use of dietary fiber gels for fat and calorie reduced soups. When substituted for fat containing compounds, dietary fiber gels reduce the fat and calorie content of food products. Dietary fiber gels are fully described in U.S. Pat. No. 5,766,662 (the '662 patent). These dietary fiber gels comprise insoluble dietary fibers consisting of morphologically disintegrated cellular structures, and are characterized by their ability to retain large amounts of water. Dietary fiber gel can be a gellable product or a gel powder depending on water content. Typically, dietary fiber gel is produced as a gellable product that is dried to remove water so as to produce a gel powder having reduced water content. Dietary fiber gels are characterized by high hydration capacity when reconstituted with water. Additionally, these dietary fiber gels are characterized by their high viscosity at low solid levels. Other insoluble fibers derived from cereals, grains and legumes derived by conventional dry milling consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations.

According to the present invention, fat and caloric content can be reduced by the replacement of the fat-containing ingredients normally found in soups with dietary fiber gel, such as shortening compositions comprising dietary fiber gel. Substituting dietary fiber gel for fat does not adversely affect either the taste or texture of the soups.

Alternatively, the soups can be provided in the form of soup mixes and condensed soup concentrates with the intention that a consumer can mix them at a convenient, post-purchase time, and soup mixes and condensed soup concentrates are considered to be within the scope of this invention. As such, for purposes of this document, the term “soups” is defined to include soup mixes and condensed soup concentrates.

The different categories of soups available to consumers can be formulated such that the soups have reduced fat and calories. Soups can be formulated such that the soups comprise 0.25 percent to 6.0 percent dietary fiber gel solids by replacing an appropriate amount, that is, prorated to deliver this range of dietary fiber gel solids, of fat, such as included in oil and liquid shortening. The result is that fat and caloric content of soups can be manipulated with minimal effect on taste and texture, and as stated above, additional health benefits can be achieved through consumption of soups comprising dietary fiber gel when functional foods are included in the formulations.

Functional ingredients can be added to the composition of soups to increase health and nutritional benefits of this food. Most notably functional foods such as high omega three and omega six oils and pure omega three and omega six fatty acids, medium chain triglyceride, beta carotene, calcium stearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources can be added to soups.

The following ranges of the functional foods in soups are given by way of example, but other functional foods, notably fat soluble functional foods, can be added as well. High omega three oils and omega six oils, for example flax seed oil, can be added in concentrations of 1 percent to 50 percent of the composition by weight. Pure omega three fatty acids and omega six fatty acids can be added in concentrations ranging from 1 percent to 30 percent of the composition by weight. If both pure omega three or six fatty acids and high omega three oils are used, their respective concentrations can be prorated to give an appropriate end concentration of high omega three fatty acids. Medium chain triglyceride can be added in concentrations ranging from 1 percent to 30 percent of the composition by weight. Fagopyritrol or foods containing fagopyritrol can be added in concentrations of 0.25 percent to 20 percent of the composition by weight. Polyphenolic antioxidants of vegetable origin, for example lycopene, beta carotene, luteine, and bioflavonoids can be added in concentrations ranging from 0.25 percent to 20 percent of the composition by weight. Soluble fiber, for example beta Glucan, can be added in concentrations ranging from 5 percent to 15 percent of the composition by weight. Any functional foods added to the composition can be added in such concentrations to deliver up to 100 percent, preferably 25 percent to 100 percent, of prevailing recommended daily intake recommendations by the FDA, European Commission, FAO, Codex Alimentarius, or other international authorities.

Although the present invention is illustrated by the example of soups, soup mixes, condensed soup concentrates, and so forth, the present invention applies to foods and food formulations that include fat containing ingredients such as oils, greases, and lards that are derived from vegetable, animal, or synthetically produced that are used in the mixing, baking, reheating or other processing as necessary to produce edible foods.

An advantage of the present invention is the ability to provide a unique composition of matter embodied by low-calorie and low-fat soups. The fat and caloric content are advantageously reduced by the replacement of the fat normally found in soups with compositions comprising dietary fiber gel. Food compositions that reduce caloric and fat content answer an unmet need in the food industry to provide the consuming public with a healthier, higher fiber alternative to traditional types of soups that typically are inherently fattening. Another advantage is the providing soups that have been fortified with insoluble fiber and other functional foods. Yet another advantage is that the fat replacement with dietary fiber gel does not adversely affect either the taste or texture of soups. Finally, the fat and caloric content of soups can be advantageously manipulated with minimal adverse effect on taste and texture, and additional health benefits can be achieved through composition of soups comprising dietary fiber gel when functional foods are included in the formulations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

1. soup, the soup having a formulation, the soup comprising dietary fiber gel, wherein dietary fiber gel is added in a prorated amount such that solids contained within the dietary fiber gel represent 0.25 percent to 6.0 percent by weight of the overall soup formulation, and dietary fiber gel replaces an equal amount of fat used in an otherwise identical recipe of soup that uses no dietary fiber gel.

2. soup of claim 1, wherein the soup is made from a soup mix.

3. soup of claim 1, wherein the soup is made from a condensed soup concentrate.

4. soup of claim 1, further comprising at least one functional food selected from a group consisting of
high omega three oil, wherein high omega three oil represents 1 percent to 50 percent of the soup by weight,
pure omega three fatty acid, wherein pure omega three fatty acid represents 1 percent to 30 percent of the soup by weight,
a combination of high omega three oil and pure omega three fatty acid, wherein the total omega three fatty acid present in the combination represents 1 percent to 30 percent of the soup by weight,
medium chain triglyceride, wherein medium chain triglyceride represents 1 percent to 30 percent of the soup by weight,
fagopyritrol, wherein fagopyritrol represents 0.25 percent to 20 percent of the soup by weight,
lycopene, wherein the lycopene represents 0.25 percent to 20 percent of the soup by weight,
polyphenolic antioxidants of vegetable origin, wherein polyphenolic antioxidants represent 0.25 percent to 20 percent of the soup by weight,
luteine, wherein the luteine represents 0.25 percent to 20 percent of the soup by weight,
beta carotene, wherein the beta carotene represents 0.25 percent to 20 percent of the soup by weight,
calcium stearate, wherein the calcium stearate represents 0.25 percent to 20 percent of the soup by weight,
vitamin E, wherein the vitamin E represents 0.25 percent to 20 percent of the soup by weight,
bioflavonoid, wherein the bioflavonoid represents 0.25 percent to 20 percent of the soup by weight,
a functional food having a daily intake reported by the United States Food and Drug Administration, wherein the soup contains 25 percent to 100 percent of prevailing daily intake recommendation by the United States Food and Drug Administration,
a functional food having a daily intake reported by the European Commission, wherein the soup contains 25 percent to 100 percent of prevailing daily intake recommendation by the European Commission, a functional food having a daily intake reported by the FAO, wherein the soup contains 25 percent to 100 percent of prevailing daily intake recommendation by the FAO, and
a functional food having a daily intake reported by the Codex Alimentarius, wherein the soup contains 25 percent to 100 percent of prevailing daily intake recommendation by the Codex Alimentarius.
